(19) United States
(12) Patent Application Publication
(10) Pub. No.: US 2001/0049084 A1
(43) Pub. Date: Dec. 6, 2001

(54) Interactive rewards-based pedagogical system using an engine of artificial intelligence

(76) Inventor: Darryl Joseph Mitry, La Mesa, CA (US)

Correspondence Address: DARRYL MITRY, 10840 QUEEN AVENUE, LA MESA, CA, 91941-7124, US

(21) Appl. No.: 09/863,618

(22) Filed: May 23, 2001

Related U.S. Application Data
(60) Provisional application No. 60/207,863, filed on May 30, 2000.

(51) Int. Cl. G09B 19/00

(52) U.S. Cl. 434/118

(57) ABSTRACT

A system is disclosed that provides an interactive rewards-based method that uses a protocol for instructional response in order to provide a motivating, individualized educational and entertaining experience. The system utilizes an interface through a computer. The system offers the user (a.k.a. student) simulated environments that represent different realities and an opportunity to solve interesting problems and learning puzzles. When the user inputs a response this calls forth a system response using the built-in Intelligent Mentor, thereby teaching the user. The iterative response process provides the user opportunities to discovery before proceeding to a higher level of the subject material. The pedagogical system uses neural nets (engine of artificial intelligence) that drive responses that are synchronized to typographical and graphical illustrations and/or pictorial illustrations used to simulate reality and to provide dynamic interactions. Stages of progression are integrated into the pedagogical system in order to provide users with individually paced experiences determined by the level of difficulty and rate of performance per time period. Users' interaction involves real-time decision-making and fusion of the educational material. It involves programs in computer medium that create a rewards-based system to provide a motivating educational and/or entertainment environment including natural attractions that further motivate continuous involvement in the learning process. Encoded lessons are enabled in the system that provide feedback on aspects of user performance such as mission management, mathematical solutions, recognition, matching, and utilizing data to solve problems and puzzles. The user receives credits each time he/she successfully completes a section. Credits are additive and may be exchanged for material rewards by using this invention of the “virtual mall” for the computer network. The rewards redemption system includes a server in communication with the users computer mechanism to form a network that may include the Internet. The credits may be saved or can be exchanged for material reward certificates. If redeemed, the student player is dispensed a specific verifiable reward acknowledgement. The computer system can also provide for competition games played for a rivalry of credits by a number of users. Reward information, such as reward costs in terms of specific credit redemption is automatically determined by the system. While this invention has been described in terms of several embodiments, it is contemplated that alterations, variations and equivalents thereof will become apparent to those skilled in the art of pedagogy upon a reading of the specification and study of the drawings. For example, many types of problems/solution sets and puzzles can be provided for use with the disclosed rewards based system, and the computer tool can be utilized for classroom teaching as well. Thus variations can be used. It is noted that the rewards-based system of redemption can be implemented on a single computer connected to other computers, with or without use of the Internet. However, the preferred embodiment illustrated here envisions that the invention will be used in a broad network such as the Internet. The provision of rewards can be achieved by redemption certificates or electronically. It is therefore intended that the claims include all such alterations, variations, and equivalents as fall within the spirit and scope of the present invention. This rewards-based pedagogical system offering lessons within simulated environments and providing for various reward redemptions represents advancement in pedagogical systems for computer-assisted learning and paradigms of progressive skill-development.

### FIELD OF THE INVENTION

The present invention relates to educational and entertainment systems and more particularly to a rewards-based system that utilizes computerized simulations of actual environments to motivate the learning of skills by the user and wherein the user is awarded credits for learning that can be redeemed for free merchandise and/or services or applied to contests for awards of larger value (such as college scholarships).

### BACKGROUND OF THE INVENTION

In every educational system, developing of student comprehension requires that there be a method of pedagogy. The system must have a pedagogical paradigm and a disciplinary authority in a subject. The pedagogical paradigm is the foundation for the constructs and the protocol that propels the content of the discipline of knowledge and the concomitant knowledge/skill set. The content of the discipline is transmitted by the pedagogical paradigm and the user's comprehension arises from the iterative process of cognitive recognition of association. The disciplinary authority has understanding of the use of the skill-set within the discipline. For example, the disciplinary authority for instructing users in engineering of spacecraft could be an aerospace engineer, and disciplinary authority for instruction in ecological systems could be a scientist and may be from a natural science disciplinary background such as a biologist, a physicist and/or a geologist. A pedagogic practitioner is a person that understands the dynamics of the instructional system and principles of cognition. The pedagogic practitioner utilizes the knowledge of the disciplinary to create an application for delivery to users through a pedagogical system. The pedagogic practitioner and the disciplinary authorities may be the same or different people. The process requires that the disciplinary authority provide theory, descriptive illustrations, questions with answers, problems and solutions, and may involve puzzles and solution-sets along with descriptive subject material. Within the design of the invention identified herein, the pedagogic practitioner incorporates this material of the disciplinary authority into the computerized paradigm of the pedagogical system, which instructs the student in the use of the information, theoretical framework and skills of the discipline. Typically the basis of this approach is exampled in a classroom or in textbooks or some digitized version of textbook materials. The attempt to transmit knowledge and information from a teacher to several users within a classroom is costly and has inefficiencies and this has lead to attempts to use computer programs and the distribution channel of the Internet for teaching. One advantage of computerized instruction is quick feedback that provides validation of the user's response. Such feedback means the user is clearly aware of the cognitive process of his/her response. Therefore, a computerized embodiment of pedagogy, through the use of an artificial intelligence engine, may be preferred to a classroom teacher, because it can provide quicker feedback to the user in a judicious and less costly manner. However, the current pedagogy of computerized systems suffers from a low level of motivational dynamics and this results in users' loss of attention, focus and quality of learning. The prior art of the previous pedagogical paradigms utilize mostly simple feedback without introducing natural attractions and real rewards. Previous paradigms lack appeal because they do not have natural attractions that help to motivate involvement in the learning process. A natural attraction is defined herein as, but not limited to, an attraction to themes and genre such as space travel (outer space and inner space), robots and dinosaurs that may be built into life-like computer simulations. The system as herein described uses these natural attractions. Furthermore, the prior art of previous paradigms may illustrate concepts but without lifelike and real-time consequences of the application of skills by the user. Also, typically these systems are based upon a singular pathway and the user is forced to navigate through a narrow pedagogic system that prevents individualized progress and navigation. The previous methods, without the pedagogical model embodied in the system of this invention, support at best only a simple feedback to the user identifying correct or incorrect answers based upon a selected response of one pathway and without progressive rewards (such as redeemable credits). Previous computerized systems have not defined the type of pedagogy proposed herein, where there is an opportunity for the dynamic life-like simulations of academic subjects depicted within a “natural attraction” and wherein there exists a protocol to provide a creative, entertaining and interactive learning environment accompanied by a progressive and redeemable reward to the user.

### SUMMARY OF THE INVENTION

In a broad characteristic of a preferred embodiment of the invention, a rewards-based knowledge system utilizes protocols based upon the pedagogical paradigm herein to provide a cognitive experience for knowledge and skill development. The system provides the user with a natural attraction and a simulated environment that presents an opportunity to understand and solve a problem and/or puzzle and then be rewarded with acknowledgement for the level of performance. Incorrect decisions are tracked by the system and corrective instruction is presented in a graphical, pictorial or typographical appearance in order to encourage the comprehension of the skill-sets that a user needs for success in a real world experience. An engine of artificial intelligence drives the individualized and immediate feedback with graphical, pictorial and/or typographical illustrations that are used as simulations of real-world consequences of the users interactions. Where possible and appropriate, alternative solutions are entered into the system by the disciplinary authority in order to allow individualized cognitive experiences wherein the navigation by the user is a stepped progression and is integrated into the pedagogical system in order to provide users with individually paced learning experiences wherein the pace of user navigation through the system is the result of the users ability to learn as determined by the level of difficulty in correct answers and rate of performance per time period. The subjects of study are modeled within simulated formats and are identified with simulated mission objectives that provide the user with experiences related to expected real world consequences of their decision-making. Users' interaction involves real-time decision-making and synthesis of the informational material. Encoded lessons are enabled in the system that provide instructional feedback on aspects of user performance such as mission management, mathematical solutions, recognition, matching, and utilizing data to solve problems and puzzles. Feedback also includes intermittent examples to guide the user in properly arriving at the correct answer and/or decision step. The user receives learning credits each time he/she successfully completes or surpasses a section of the simulation challenge. These credits are additive and may be exchanged for material rewards by using the computer interface and network. This integrated systems approach to computerized pedagogy, having an individualized mentoring process (neural nets) within life-like simulations and providing for selection of real awards via a computer network, distinguishes the invention from previous methods.

### DESCRIPTION OF THE DRAWINGS

The foregoing descriptions and other material aspects may be understood from the following description of a preferred embodiment of the invention with reference to the drawings, in which:

FIG. 1 is a diagram of representative hardware configuration for a personal computer in accordance with a preferred embodiment;

FIG. 2 is a diagram of a general system architecture in accordance with a preferred embodiment;

FIG. 3 depicts the tasks of teaching and learning with feedback response and intelligent tutoring within a simulated setting in accordance with a preferred embodiment;

FIG. 4 depicts the presentation and selection of product/service awards and redemption of credits within the virtual mall in accordance with a preferred embodiment;

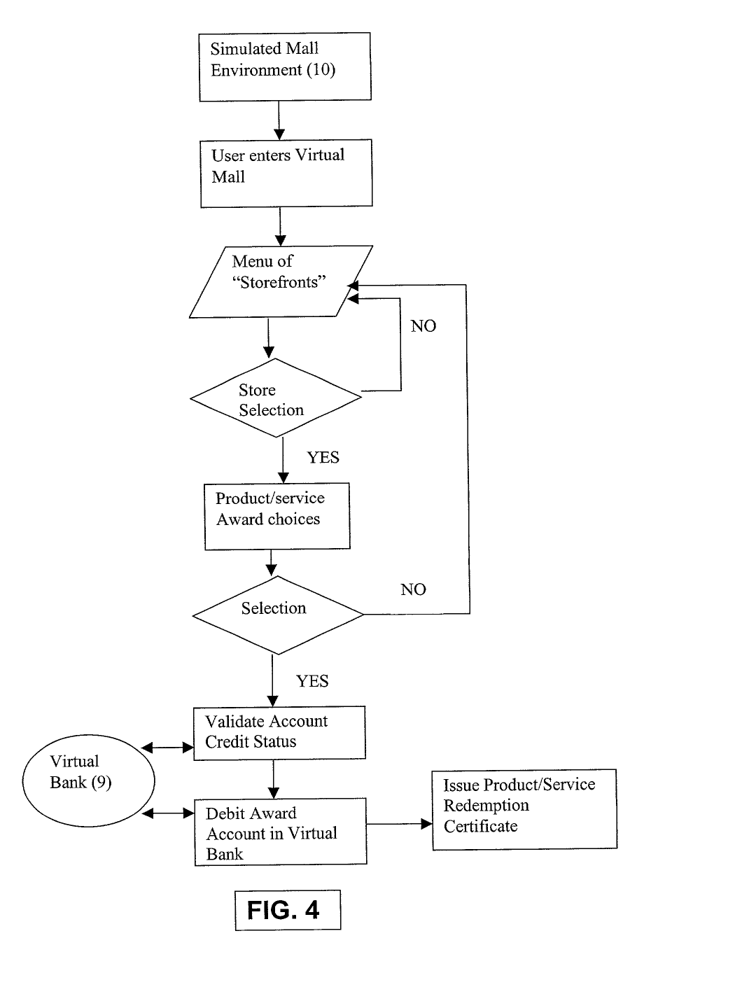

### DETAILED DESCRIPTION OF INVENTION

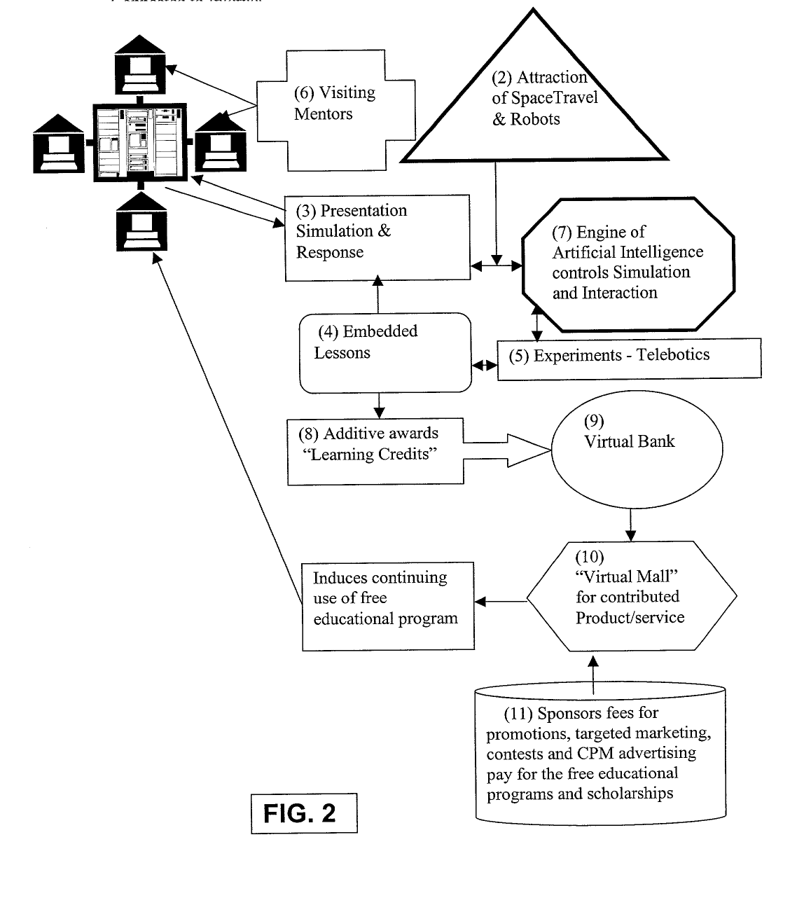

A synopsis of the preferred embodiment as contained in the drawing (FIG. 2) is stated as:

1. Students having access to computers connected to Internet service are linked to the Company's computer servers that host the interactive educational programs.

2. The Company's programs use natural attractions of space travel and robotic adventures that produce the strong initial attraction for student participation.

3. Simulation dynamics and the interactive game format serve to entertain and maintain interest during learning sessions.

4. Embedded skill-based lessons progressively advance student skill levels and serve to accelerate student learning and instill confidence in all areas of study.

5. The students' application of the learned skills to space missions, robotics and science experiments promote student excitement, enthusiasm, personal identification and commitment to the ongoing program. Telebotics allows students to control experiments by local computer with the execution by equipment located at distant locations elsewhere, and thereby allow students to learn skills applicable to the digital economy.

6. Coordination of online programs with a live-mentors program using professionals and high school and/or college students facilitates identification of younger students with the older students and promotes common goals throughout K-18 grade levels.

7. Engine of Artificial Intelligence: controls interactions.

8. The progressive awards function of learning credits is used to motivate the continued student involvement.

9. Virtual Bank: The provision for students to save their credits in the “Virtual Bank” allows for higher-level rewards teaching economic principles; developing personal financial management skills.

10. Virtual Mall: The after-school online virtual “Mall” provides opportunities for the corporate sponsors to give away product and promote their product brands while establishing customer loyalty. The provision for the student to use their learning credits to actually claim material rewards, promotions and discounts on merchandise (that are supplied by sponsors) promotes passion and reliance behavior on the part of students obtaining free merchandise.

11. Sponsors support the program, paying for “residence” marketing value that is determined and calculated in the manner that is customary for targeted marketing promotions and campaigns (for example: online CPM, and licensing fees for promotional products, etc.) thereby helping to underwrite the educational content for students.

Hardware Embodiment:

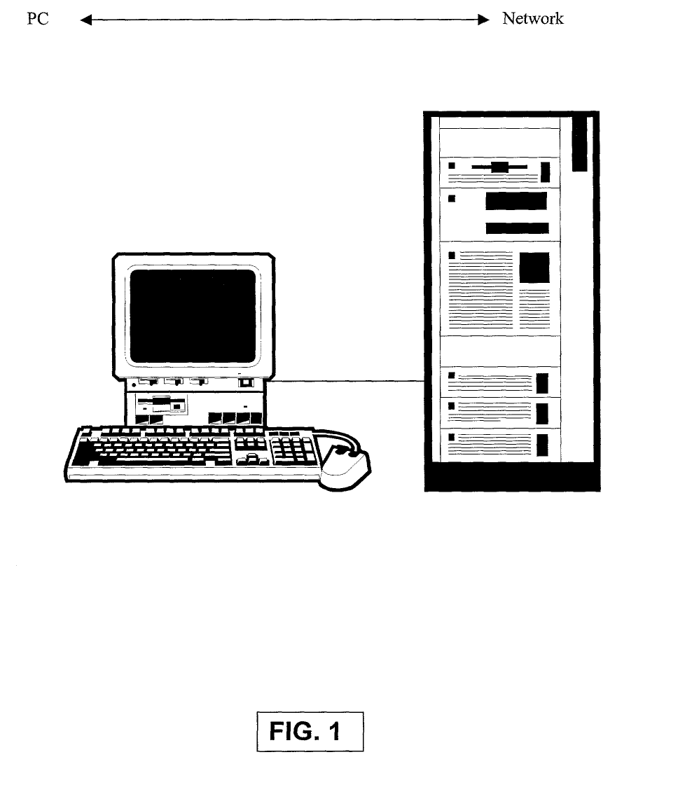

A preferred embodiment of a system in accordance with the present invention is preferably used in the context of a personal computer connected to Internet. A representative hardware environment is depicted in FIG. 1, which illustrates a typical hardware configuration of a personal computer in accordance with a preferred embodiment having a central processing unit, such as a microprocessor, and a number of other units interconnected in a system. The computer in FIG. 1 includes Random Access Memory (RAM), Read Only Memory (ROM), I/O adapter for connecting peripheral devices, user interface adapters for connecting a keyboard, a mouse, speakers, and/or other user interface devices, a communication adapter for connecting to a communication network (e.g., the Internet) and a display adapter for connecting to a display device. The computer has an operating system such as the Microsoft Windows NT or Windows 2000 Operating System (OS), or MAC OS operating system. Those skilled in the art will appreciate that the present invention may also be implemented on platforms and operating systems other than those mentioned.

Software Embodiment:

A preferred embodiment is written using JAVA and/or Active X, and C++ language and utilizes object oriented programming methodology (OOP); a mainstream method of software development. The OOP process of developing computer software using objects includes the steps of analyzing the problem, designing the system, and constructing the program. Each object is a software packet containing data and a compilation of related procedures. Because it contains data with structures and procedures, it can be visualized as a self-standing programming unit ready to perform its specific task. With OOP we view the computer program as a set of these programming units through component integration architecture that is a set of architectural mechanisms that allow the software modules to utilize each other's functions with in a framework. This represents a useful generic design solution for a assortment of problems in any given domain. For example, a framework can embody the way a user interface works, even though two different user interfaces created within the same framework might solve interface problems that are different. Therefore the framework embodies the way a group of related programs or pieces of software work. In this manner, the development of frameworks for solutions to various problems and programming tasks produce significant reductions in the time for design and development of the software. A preferred embodiment of the invention utilizes Hyper Text Markup Language (HTML) to implement documents on the Internet together with a general secure communication protocol for transport between the user and the network. Other protocols can be substituted for HTML without undue experimentation and information on such protocols is readily available. HTML is a data format used to create hypertext documents that are “portable” from one platform to another. HTML has been in use by the World-Wide Web global information initiative since 1990. Until recently, Web development tools have been limited in their ability to create dynamic Web applications, because HTML by itself produces static Web pages. However, the Java language (by Sun Microsystems) enables the creation of dynamic real-time Web applications. Sun's Java language has emerged as a language for programming the Internet. Java based on C++ supports programming for the Internet in the form of platform-independent Java applets allowing developers to add interactive content to Web pages (e.g., animations and simple games). Applets execute within a Java-compatible browser such as Netscape Navigator or Explorer by copying code from the server to client. Another technology, called ActiveX, provides functions much like JAVA for building the dynamic content for Internet and personal computers. ActiveX includes tools for developing 3-D virtual reality, video, animation and other media content on multiple platforms. The building-blocks are referred to as ActiveX Controls and allow embed parts of software in hypertext markup language. These ActiveX Controls also work with a variety of programming languages including C++ and Jakarta. One ordinarily skilled in the art recognizes that ActiveX could be substituted for JAVA without undue experimentation in the practice of the invention. Indeed, some of the future changes envisioned include even more robust programming codes and languages yet unavailable for public use. The term Neural Net refers to the underlying concept for the engine of artificial intelligence. Neural networks are formed from hundreds or thousands of simulated neurons (brain cells) connected together in a similar way as the human brain has neurons are interconnected. Neural networks learn from experience (inputs and outputs), not from programming (see http://www.calsci.com/whatare.html).

Program relation to Engine of Artificial Intelligence:

An engine of artificial intelligence also regularly referred to as a simulation engine in accordance with a preferred embodiment is based on neural-nets. These produce graphic models that can simulate real world behavior and can represent a task that is performed by a user (student). The Engine accepts inputs and calculates various outputs and notifies the system of the status of the simulation at a given time in order to obtain appropriate feedback. The simulation model executes the mission and manipulates the subject embedded lesson for the user. The user inputs data into the simulation engine and receives an output from the model. For example, if the user is calculating a flight trajectory of a spacecraft, his/her calculations transmit as inputs to the simulation model and the flight path is calculated and shown as the output. As calculations pass to and from the simulation model, they are being transmitted to the software Intelligent Mentor (IM). The IM evaluates the data implications and generates feedback responses according to the progress of the user. The feedback responses are displayed to the user and may include recommendations for changes in user calculations.

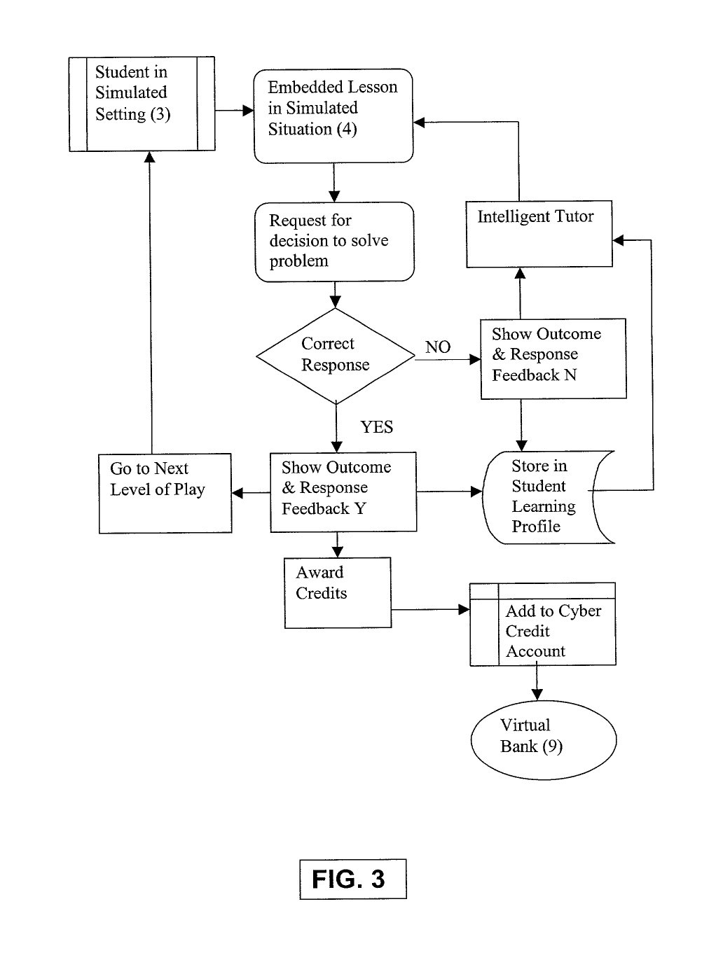

FIG. 3 is a diagram of system architecture in accordance with a preferred embodiment wherein the preferred embodiment allows users to acquire complex skills as they “play” in the simulated environments that represent challenging real-world situations and simulated mission objectives. Thus the system utilizes leaning-by-doing pedagogical theory and the latest computer assisted technologies. Therefore, a software component consists of a mathematical modeling tool that simulates real world outcomes of a user's series of actions over the period of time in the simulation. Another component is a disciplinary information module as identified in the Content Cookbook, and in the program itself it consists of coded strings that organize pre-packaged information similar to a text book with practice exercises, scenarios, and a dictionary of definitions. Concurrently, there exists the software's Intelligent Mentor that encompasses the engine of artificial intelligence and thereby generates instructional messages to the user. It is intended that the simulations characterize alternate environmental pathways, wherein users can navigate the application along various paths, depending on their learning ability and previous experience. Therefore, response feedback as a series may be different for each individual and support alternative messages that are designed for each of the lessons. The simulation methodology described herein includes description for support of content acquisition, the interactive considerations for response feedback and the mentoring process itself. All such functions are then built into the system in accordance with a preferred embodiment. Many different learning interaction operations are also included in accordance with a preferred embodiment, such as asking for help through menu, performance status review, forecasting for impact of decisions, and others. Useful response feedback is an important part of these simulation designs because the response feedback is the primary means to communicate if the user action is assisting him/her meet the mission objectives. The response feedback takes the form of messages such as “you are in trouble because flight path is below required level. Adjust upward path accordingly” or “Good work, you are on target with flight path trajectory” as may serve to illustrate response feedback in accordance with a preferred embodiment.

Compared with Existing Designs:

The usual pedagogies used in classrooms and also on the Internet sites largely involve only description and the traditional method of memorization of facts. These depend upon what may be referred to as the “show and tell” method of presentation coupled with testing for memorization of facts. The problem with these pedagogical models is that they do not provide really powerful opportunities for learning. For example, if people were taught to ride a bicycle in the same manner as they are often taught science or history, few people would actually learn how to ride a bicycle, and years later even fewer people would remember. People learn better by the experience and experimentation, and not by mere description, illustration and memorization. Indeed a review of numerous educational Web sites discloses that they consist largely of descriptive material, and where links are provided to other Web sites we only find more descriptive material. Therefore, the existing pedagogy of these sites is simply “show and tell” with little or no true skill-base interactivity. Furthermore, they lack any effective rewards-based association to promote active involvement with reaching learning objectives. The system described herein is based on a pedagogical method wherein the user (e.g. student) is engrossed in the program by use of attractive themes, and receives reward recognition for performance, and thereby gains the skills through experimentation and the ability to perform desirable tasks. The key to this system is the integration of simulations with reward opportunities for meeting skill-based performance measures related to real-world expectations and the opportunity for reward recognition. In this embodiment, users have all the necessary support components available that are required for real world insinuation applications. Learning within the system of this invention is therefore a continuous iterative experience similar to “real on the job” experience that is continuous iterative learning in a real world environment.

A typical computer assisted content curricula using the method of development presented herein should take eight to sixteen weeks to complete. The following identifies and illustrates an approach to development architecture in accordance with a preferred embodiment and resource step requirements for each phase of development for a typical subject application in accordance with a preferred embodiment. This identifies the steps required for the building stage, testing stage, and implementation stage. The tools and architectures described herein are part of a next-generation for a simulation framework that will build solutions in accordance with a preferred embodiment.

Stages of Development

Stage 1: In the first stage of development, an instructional designer (ID) introduces one or more disciplinary experts (DE) to the format herein referred to as the Content Cookbook (CC). Subsequently, in stage 2, the disciplinary expert(s) begin writing the lesson plan along the lines of the intended simulation(s). Upon completion of the initial draft of the CC, in stage 3 the instructional designer is then reoriented to the content and begins to conceptualize the details of the instructional visualization. The ID may make inquiries to the disciplinary expert(s) regarding the subject material in the initial Content Cookbook.

The ID adopts the learning objectives as identified in the CC. The ID suggests and negotiates with the DE regarding designs for the user (student) interactions and interface. Subsequently, additional experts may be used to evaluate the intended design. The disciplinary experts then revise the CC accordingly, stage 4.

Initial Construction Stage

During this stage, the application development team consisting of the original ID in consultation with other software programmers, uses the revised Content Cookbook to code the application. Coding tasks include all the interfaces users will encounter. The interfaces may consist of pull-down menus, operational buttons, select answer lists, or any other screen controls that allow the user to interact with the simulation and move toward the intended mission objective(s). Additionally, the program developer codes the logic that analyzes the user's input and provides response feedback. The response feedback consists of text and/or graphical illustrations, video and audio directions taken from the revised CC.

Piloting Trial Stage

Trials are run with a limited number of initial users. Here the initial users experience with the pilot programs are observed and outcomes recorded. A panel consisting of one or more disciplinary experts, users, teachers and instructional designers evaluates findings of the experience with the initial pilot programs. Next, the modified design is determined. The Piloting Trial Stage is testing the application in terms of proper functions and all user requirements and intended Learning outcomes. Assuming that the application fails to function as intended, it is then “debugged” and recompiled. Usability testing is accomplished by testing users (students) unfamiliar with the application. Assuming that usability is found to be unsatisfactory, then aspects of the interface and/or response feedback are adjusted. The resulting changes are coded and re-tested for usability. The modified design is then submitted for final encoding.

Implementation Stage

During implementation the design team continues to receive user feedback and periodic changes may be made to the original program accordingly.

Operational Outcomes

The system for the rewards-based-skill-development simulation environment embodied herein is intended for use by students in K-16 grade levels and may also be used for participation of the public at large. In order to implement the rewards-based approach embodied in the system described herein, it is necessary to track the users' levels of performance and record the associated learning credits in the associated User Profile (UP) for each participant. For K-16 grade levels the teachers and parents of users may also want to track students' progress in the course of studies. Therefore, as a student performs activities within the lessons, his/her progress is recorded in the UP. The UP identifies the accomplishment of mission objectives and verifies the degree of success in meeting the learning outcomes. The UP is password protected and the summary data is only available to the user and the user's authorized teacher and his/her parents as may also be authorized.

We claim the following:

1. A method for creating rewards-based learning paradigms utilizing a protocol of an instructional response system with data banks that include data and calculations required for mission simulation and communication of information as response feedback in order to provide a motivating and individualized experience, comprising the steps of:
(a) using the information in the data banks of the rewards-based system to integrate mission objective learning information in a structured dynamic simulation and designing a profiling of the user in order to motivate accomplishment of the learning objective or goal;
(b) obtaining the information in the data banks of the rewards based system to retrieve information indicative of a completing a learning objective or goal;
(c) tracking user answers to questions and/or puzzles to evaluate a user's progress toward the mission objective using the rewards-based system and providing feedback information from a corrective data component including a software Mentor encompassing an engine of artificial intelligence that produces messages that further serve to motivate user to accomplishment of the mission objective.

2. A method for creating mission simulations as recited in claim 1, wherein data processing related to solving learning problems and/or puzzles is integrated into the presentation.

3. A method for creating rewards-based simulation as recited in claim 1, wherein the knowledge of history, scientific, and mathematic principles and data are integrated into the simulation and presentation

4. A method for creating rewards-based simulation as recited in claim 1, wherein recognition and matching material is integrated into the presentation.

5. A method for creating rewards-based simulation as recited in claim 1, including the step of adjusting an example based on user progress per time period.

6. An apparatus that creates a rewards-based simulation utilizing a protocol system with a data bank component to provide a rewards-base environment, comprising:
(a) a processor;
(b) Interface mechanisms such as a computer mouse, mobile telecommunications device, voice recognition mechanisms, joy-stick or a keyboard under the control of the processor for inputting information into the system;
(c) a display unit under the control of the processor;
(d) a memory that stores information in the data banks component of the rewards-based system under the control of the processor that includes protocols for calculations required for the simulation and communication of response feedback information;
(e) logic that accesses the data in the data banks component of the rewards-based system to retrieve information indicative of mission objectives and to integrate learning of subject principles and to provide information that motivates accomplishment of the mission objectives;
(f) logic that tracks user answers to questions and/or puzzles presented in order to evaluate user progress toward the mission objective utilizing the data bank component of the rewards-based system and provides corrective feedback from a data bank component including an information system and a software mentor comprising an engine of artificial intelligence that generates individualized messages that further serve to motivate accomplishment of mission objectives; and
(g) logic that automatically adjusts the amount and type of response feedback based upon the user's progress toward the mission objectives.

7. A software program embodied in a computer medium that creates rewards-based mission objectives, puzzles and problems to solve in a graphical and/or typographical simulation utilizing a rewards-based system that includes data, calculations required in simulation, and communication of information to provide a rewards-based environment, comprising:
(a) a code segment that receives and accesses the information in the data banks component of the rewards-based system to retrieve information indicative of a mission objective to integrate information in a dynamic simulation designed by a profiling component that motivates accomplishment of the mission objectives;
(b) a code segment that tracks answers to questions and/or solutions to problems or puzzles in order to evaluate the user's progress toward the mission objective utilizing the data banks component of the rewards-based system and provides feedback from a component including an information system and a software-mentor comprising an engine of artificial intelligence that generates individualized prompting messages that further motivates accomplishment of the mission objectives; and
(c) a code segment that adjusts the amount and type of feedback and individually paced experiences based on the user's progress toward the mission objective, with individually paced experiences wherein the pace of user navigation through the system is the result of the users ability to learn as determined by the level of difficulty in correct answers and rate of performance per time period.

8. A program embodied in a computer medium that creates rewards-based mission objectives, puzzles and problems to solve in a graphical and/or pictorial and/or typographical simulation utilizing a rewards-based system that includes data, calculations required in simulation, and communication of information to provide a rewards-based environment, as recited in claim 7, wherein the subject of mathematics and/or science, and/or engineering and/or psychology and/or sociology and/or biology, and/or economics and/or language, and/or art and design, and/or scientific processing and calculation is integrated into the simulation.

9. A program embodied in a computer medium that creates a graphic, pictorial or typographical simulation utilizing a rewards-based system with a data bank component to provide a motivating and entertaining environment, as recited in claim 7, including natural attractions that motivate continuous involvement in the learning process (natural attraction is defined as an attraction to themes and genre such as space travel, outer space and inner space, robots, romantic or exotic realms, time travel and/or dinosaurs).

10. A program embodied in a computer medium that creates a graphic, pictorial or typographical simulation utilizing a rewards-based system with a data bank component to provide a motivating and entertaining environment, as recited in claim 7, including the step of user receiving credits that may be additive and exchanged for material rewards as incentive to the user through the use of a computer network or wherein the student player is given a reward certificate or digital recognition that is redeemable for a selected product or service as may be identified in the virtual “mall” component of this invention.

11. A program embodied in a computer medium that creates a graphic, pictorial or typographical simulation utilizing a rewards-based system with a data bank component to provide a motivating and entertaining environment, as recited in claim 7, wherein a learning game is provided for a user to play and be rewarded with credits, that may be exchanged for rewards or certificates, and are credited to the student user based on the outcome of the learning game (simulation); wherein there is a menu including one or more rewards, where the player may select a reward that has a cost within the player's credited account.

12. A program embodied in a computer medium that creates a graphic, pictorial or typographical simulation utilizing a rewards-based system with a data bank component to provide a motivating and entertaining environment, as recited in claim 7, wherein the ratio of points to reward redemption may be controlled by an operator and changed according to the competitive outcomes and/or the amount of inventory of specific rewards available for distribution.
